(19) United States
(12) Patent Application Publication
(10) Pub. No.: US 2003/0065167 A1
(43) Pub. Date: Apr. 3, 2003

(54) Process for preparing a directly compressible beta-cyclodextrin, and directly compressible beta-cyclodextrin thus obtained

(76) Inventors: Jose Lis, La Gorgue (FR); Philippe Lefevre, Haverskerque (FR)

Correspondence Address: HENDERSON & STURM LLP, 1213 MIDLAND BUILDING, 206 SIXTH AVENUE, DES MOINES, IA, 50309-4076, US

(21) Appl. No.: 10/091,917

(22) Filed: Mar. 6, 2002

(30) Foreign Application Priority Data
Mar. 8, 2001 (FR) 01 03156

(51) Int. Cl. C08B 37/16

(52) U.S. Cl. 536/103

(57) ABSTRACT

The invention relates to a process for preparing beta-cyclodextrin which is of high compressibility and which is stable over time, characterized in that it comprises a step of dehydrating hydrated beta-cyclodextrin to a water content of less than 6%, preferably less than 4% and more preferably still less than or equal to 2% by weight, followed by forced rehydration to a water content greater than 10%, preferably greater than 12% and more preferably still greater than or equal to 13% by weight.

It also relates to the directly compressible beta-cyclodextrin obtained by means of the said process.

The subject of the invention is a process for preparing a beta-cyclodextrin for direct compression. More precisely, the subject of the invention is a process for preparing a beta-cyclodextrin possessing high compressibility and stable over time in order to use it as direct compression excipient-binder. It also relates to the directly compressible beta-cyclodextrin thus obtained.

Cyclodextrins, macrorings containing six, seven or eight glucose units depending on whether alpha-, beta- or gamma-cyclodextrin is involved, are widely described in the literature, in particular for their properties of solubilizing and stabilizing various compounds. These properties, essentially due to their capacity to form a complex in the presence of compounds capable of becoming embedded, completely or partially, inside these macrorings, are of real interest in the food, pharmaceutial and plant-protection industries.

Among the existing three types of natural cyclodextrins, beta-cyclodextrin, which will be called hereinafter more simply βCD, has been the subject of numerous studies in the pharmaceutical field, which studies are oriented almost exclusively towards its optimum encapsulating properties. Numerous articles highlight the excipient properties of βCD, and suggest a definite value in galenic pharmacy.

One of the principal galenic techniques is direct compression. The production of tablets by direct compression requires that the powder used is compressible, that is to say that it forms a cohesive and hard tablet under the action of pressure, but also that it possesses a particle size sufficient for use on compression presses.

Indeed, a powder with an excessively low particle size will exhibit two defects which rule out its use, which are a lack of flow, or an insufficient flow to fill the bottom dies at the rate imposed by the compression presses, and the introduction of fine particles between all the moving parts, with, as a consequence, phenomena of seizing, slowing down and stoppage of the machine, but also problems of pollution.

While the α- and γ-cyclodextrins exhibit the desired compressibility at particle sizes compatible with production on compression press, the β-cyclodextrins of the prior art exhibit insufficient compressibility at the desired particle size, and an excessively low particle size when the powder is compressible. Indeed, the cohesion capacity is then due to the small size of the particles. Moreover, the small compressible particles are often obtained by spray-drying and exhibit the defect, apart from the small size of these particles, of producing βCD powders with reduced water content which are unstable in powdered or tablet form, under ordinary climatic conditions of storage.

It therefore appeared that there was no βCD capable of direct compression, that is to say without prior granulation. Research studies have been carried out to try to prepare physical mixtures of βCD and active agents, for direct compression. These research studies have shown that the compressibility of βCD was very variable and that the flow properties were not satisfactory for use on an industrial scale.

The studies by GIORDANO et al. (Int. J. of Pharmaceutics, 62 (1990) 153-156) have shown that the water content of βCD played an important role. Indeed, anhydrous βCD is less compressible than hydrated βCD.

However, these studies have shown that tablets prepared from rehydrated anhydrous βCD were unstable over time. Indeed, a 50% loss of compressibility was observed after 20 days of storage.

An unsatisfied need therefore existed for a βCD exhibiting optimized functional properties for direct compression. On the strength of this fact, the Applicant Company therefore sought to develop a process for preparing directly compressible βCD.

The invention therefore relates to a process for preparing βCD which is of high compressibility and which is stable over time, characterized in that it comprises a step of dehydrating hydrated βCD to a water content of less than 6%, preferably less than 4% and more preferably still less than or equal to 2%, followed by forced rehydration to a water content greater than 10%, preferably greater than 12% and more preferably still greater than or equal to 13%. The Applicant has indeed demonstrated, after long research studies, that the rate of rehydration of a dehydrated βCD combined with a particular dehydration threshold was of crucial importance in the quality and the stability of the compressibility of the final product.

Thus, compressibility which is optimum and stable over time is obtained when the βCD undergoes dehydration to a water content of less than or equal to 6% by weight, followed by forced rehydration to a water content greater than or equal to 10%.

The expression forced rehydration is understood to mean rapid and nonnatural rehydration, which is distinguishable from the prior art techniques consisting in a slow water regain, in a controlled-environment cabinet or in the open air. The rate of rehydration according to the invention is therefore higher than that of the prior art techniques applied to βCD.

The dehydration is carried out by any drying means known to persons skilled in the art. It may be carried out, for example, on a fluidized bed dryer, on a vacuum dryer or using a microwave oven.

As regards rehydration, it may be carried out on any type of equipment allowing rapid rehydration, for example in a fluidized air bed granulator or in a continuous mixer-granulator.

The temperatures for carrying out the dehydration depend on the equipment used. Preferably, a fluidized air bed dryer-granulator, with air previously dehydrated on a cooling battery at 4° C. and then heated to the maximum temperature possible, that is about 120° C., will be used. This step is carried out until the desired water content is obtained.

The rehydration is preferably carried out on the same equipment after cooling. The dryer-granulator is cooled with air injected at a temperature of 20° C. When the temperature of the product is less than 60° C., water is then sprayed, for example, at a flow rate of 800 ml/minute, and at a rate of 13 litres per 100 kg of initial powder load. This step is carried out until the desired water content is obtained. The temperature at which this rehydration is carried out is preferably less than 40° C. Indeed, above this temperature, an onset of granulation is observed which requires additional sieving so as to remove the granules formed.

According to one variant of the process in accordance with the invention, the βCD is sieved, most generally so as to obtain a particle size range of between 100 and 200 micrometres. This sieving may be carried out before or after each step of the process. Preferably, it is carried out just before the rehydration step.

The process in accordance with the invention thus makes it possible to obtain a directly compressible beta-cyclodextrin exhibiting improved compressibility while being perfectly stable during storage.

This βCD is characterized by a compressibility greater than 70 N expressed in a C test. This C test consists in measuring the force, expressed in Newton (N), which is representative of the compressibility of the powder studied. This force gives the resistance to crushing of a tablet which is cylindrical and flat, with a diameter of 13 mm, with a thickness of 5 mm, and with an apparent density of 1.2 g/ml. It is particularly surprising that a βCD prepared according to a process in accordance with the invention can simultaneously exhibit this markedly improved compressibility compared with the prior art products, and be perfectly stable over time.

The βCD obtained according to the process in accordance with the invention is, on the other hand, characterized in that it has a specific surface area, on the fraction between 100 and 160 micrometres, greater than or equal to 1.0 m²/g, a mean particle diameter greater than 80 micrometres and an apparent mass density on the fraction between 100 and 315 micrometres greater than or equal to 0.45 g/ml, preferably greater than or equal to 0.50 g/ml.

The specific surface area is determined using a Quantachrome specific surface area analyser, based on a test of absorption of nitrogen onto the surface of the product subjected to the analysis, according to the technique described in the article BET Surface Area by Nitrogen Absorption, by S. BRUNAUER et al. (Journal of American Chemical Society, 60, 309, 1938).

The βCD obtained according to the invention exhibits, in addition, a stability greater than or equal to six months at room temperature.

Stability is understood to mean a variation in the compressibility according to the C test of less than 40%.

The invention will be understood more clearly on reading the examples which follow, which are intended to be illustrative and non limiting.

### EXAMPLE 1

### Influence of the Dehydration/Rehydration Levels

Directly compressible βCD is prepared by dehydration in a controlled-environment oven and rehydration by means of a STREA-1 fluidized air bed dryer-granulator marketed by the company AEROMATIC.

Various dehydration/rehydration levels and their influence on the properties during compression of the samples obtained are studied. The moisture level is checked after each operation by measurement on a METTLER LP 16 desiccator. The moisture is displayed directly in percentage relative to the weight of nondried starting materials.

The compressibility of the powders obtained and of the starting βCD is determined according to the following C test:

Tablets are prepared from test powders to which 1% by weight of magnesium stearate is added beforehand as lubricant.

The compression is performed on a FROGERAIS type AM alternating press, equipped with flat dies 13 mm in diameter. The penetration of the top die and the bottom die filling volume are set on the press so as to obtain tablets having a density of 1.2 for a thickness of 5 mm, and the corresponding hardness, expressed in Newton, is determined using a SCHLEUNIGER-2E durometer.

The variation in particle size can influence the compressibility test; it is therefore important to express this test for a specific fraction. Indeed, flow is improved by increasing the particle size.

The particle size fraction of the samples tested is therefore defined as follows:

| Size in | | | | |
|---|---|---|---|---|
| Micrometres | | | | |
| (μm) | 200 to 160 | 160 to 125 | 125 to 80 | 80 to 50 |
| % | 30 | 30 | 20 | 20 |

The table below presents the various trials carried out, varying the dehydration/rehydration levels.

| | | | Schleuniger |
|---|---|---|---|
| | | | hardness |
| | Dehydration | Rehydration | (C TEST) |
| Trial No. | (% water) | (% water) | (N) |
| 1 | 1.2 | 13.07 | 134 |
| 2 | 2.19 | 14.05 | 156 |
| 3 | 2.42 | 10.94 | 94 |
| 4 | 4.74 | 13.1 | 100 |
| 5 | 4.75 | 13.06 | 115 |
| 6 | 4.8 | 13.12 | 122 |
| 7 | 4.82 | 10.17 | 98 |
| 8 | 4.96 | 14.85 | 111 |
| 9 | 5.04 | 13.01 | 110 |
| 10 | 5.1 | 12.82 | 121 |
| 11 | 7.19 | 13.9 | 100 |
| 12 | 7.29 | 11.3 | 70 |
| 13 | 8.08 | 12.76 | 78 |
| initial βCD | — | — | 25 |

These results demonstrate that very good results are obtained for a dehydration of less than 6% and a rehydration greater than 10%. The best compressibility is obtained during a dehydration of less than or equal to 2% and a rehydration greater than or equal to 13%. These results demonstrate, in addition, that these two criteria must be simultaneously fulfilled in order to obtain good compressibility.

The βCD obtained according to the process in accordance with the invention undoubtedly exhibits a markedly greater compressibility than the native βCD.

### EXAMPLE 2

### Use of a Process According to the Invention on a Fluidized Bed Dryer-Granulator

The capacity of βCD to be made according to the invention is studied on a fluidized air bed dryer-granulator and tested on a GPCG 15—GLATT type equipment (BINZEN).

The quantity of βCD used is 20 kg per trial.

The dehydration is carried out at a temperature of 120° C., and using air dehydrated beforehand on a cooling battery at 0° C. The final water content is less than 2%. Various heating periods are studied.

The rehydration is performed by spraying water, at various flow rates and temperatures. The final water content is greater than or equal to 13%.

The various samples are tested according to the C test in accordance with the invention. The results are presented in the following table:

| | Trial 1 | Trial 2 | Trial 3 | Trial 4 | Trial 5 |
|---|---|---|---|---|---|
| Drying | | | | | |
| Temperature of | 120° C. | 100° C. | 120° C. | 120° C. | 120° C. |
| the inlet air | | | | | |
| Air flow rate | 550 | 550 | 400 | 550 | 550 |
| (m³/h) | | | | | |
| Drying kinetics | | | | | |
| (% H₂O) | | | | | |
| 4 min | 10.9 | 13.0 | 12.4 | 13.0 | 12.3 |
| 8 min | 9.9 | 11.4 | 10.7 | 11.9 | 11.2 |
| 12 min | 7.4 | 11.0 | 9.3 | 10.3 | 9.8 |
| 20 min | 2.0 | 6.8 | 5.2 | 6.3 | 1.5 |
| 30 min | 1.6 | 2.7 | 1.4 | 1.6 | — |
| Water content at | 1.6 | 1.1 | 1.3 | 1.4 | 1.5 |
| the end of drying | | | | | |
| Rehydration | | | | | |
| Cooling of the | Yes | Yes | Yes | No | No |
| equipment | (10 min) | (22 min) | (9 min) | | |
| Water flow rate | 270 | 360 | 360 | 360 | 550 |
| (g/min) | | | | | |
| Duration of | 13 min | 8.5 min | 10.0 min | 10.5 | 7.0 min |
| spraying | | | | min | |
| Temperature of | 40° C. | 30° C. | 48° C. | 55° C. | 55° C. |
| the air (inlet) | | | | | |
| Water content | 13.5% | 13.7% | 13.4% | 12.4% | 13.7% |
| at the end of | | | | | |
| rehydration | | | | | |
| Total duration | 53 min | 86 min | 55 min | 43 min | 31 min |
| of the treatment | | | | | |
| Particle size | 122 | 101 | 124 | 93* | 85* |
| (mean diameter | | | | | |
| in μm) | | | | | |
| C test (N) | 90 | 136 | 76 | 129 | 163 |

* Trials 4 and 5 used rehydration of the product at 55° C. At this temperature, an onset of granulation was observed which required sieving in order to remove the agglomerates formed. This explains the particle size obtained for these two trials, which is slightly less than the other trials.

All the samples made exhibit the desired compressibility. The cooling of the powder before rehydration is found to be optional. The quantity of water to be sprayed depends on the temperature of the air and the rate of spraying.

The variations in the C test are due to the differences in the particle size of the powders. cl EXAMPLE 3

### Study of Stability

βCD is prepared according to trial 2 of Example 1.

Three samples are prepared: initial βCD, dehydrated βCD and rehydrated βCD. These three samples are stored in plastic packagings at 20° C., 55% relative humidity for more than six months.

The water contents before and after storage are measured, as well as the compressibility according to the C test.

The results are given by the following table:

| | | | Rehydrated βCD |
|---|---|---|---|
| | | | according to |
| | Initial βCD | Dehydrated βCD | the invention |
| Initial water | 11.4% | 0.9% | 13.3% |
| content | | | |
| Water content | 13.7% | 8% | 12.9% |
| after storage | | | |
| C test before | 25 N | <10 N | 156 N |
| storage | | | |
| C test after | <10 N | <10 N | 151 N |
| storage | | | |

It is observed that the water regain of the βCD obtained according to a process in accordance with the invention is very low. Furthermore, the compressibility is practically identical after six months of storage (a reduction in hardness of 3% is observed), which reflects an excellent stability.

### EXAMPLE 4

### Compressibility in the Presence of an Active Agent

Tablets are prepared with an increasing level of crystallized vitamin C, on a FETTE Exacta 21 alternating press.

The tablets have a flat shape, and have a diameter of 10 mm for a thickness of 4 mm.

The maximum hardness of each tablet is measured on an ERWEKA type TBH 30 GMD durometer.

The results are given by the following table:

| Content of | | | | | |
|---|---|---|---|---|---|
| vitamin C (%) | 0 | 5 | 10 | 25 | 50 |
| Maximum hardness | 195 | 195 | 195 | 135 | 65 |
| of the tablets | | | | | |
| (N) | | | | | |

High hardness values are obtained up to vitamin C contents of 50%, although vitamin C on its own is reputed to be noncompressible.

This illustrates the power of compression as a binder which is particularly satisfactory for the βCD obtained according to a process in accordance with the invention.

### EXAMPLE 5

### Comparison With Prior Art Products

A C test is carried out according to the invention on various prior art βCDs:

RINGDEX B and BR (MERCIAN)

CELDEX P (NIHON SHOKUHIN KAKO)

The tablets are then stored at room temperature and 54% relative humidity for two days and their hardness is measured according to the C test after two days.

The results are given by the following table:

| | | | | Hardness |
|---|---|---|---|---|
| | | | | according |
| | | Mean | | to the |
| | | dia- | | C TEST |
| | | meter | | after |
| | | of the | | 2 days at |
| | WATER | particles | | 20° C. and |
| | CONTENT (%) | (μm) | C TEST (N) | 54% RH |
| 1: RINGDEX B | 3.8 | 60 | 154 | 94 |
| 2: RINGDEX BR | 3.4 | 125 | 58 | 0 |
| 3: CELDEX P | 5.4 | 53 | 185 | 80 |
| βCD according to | 13.7 | 100 | 140 | 128 |
| the invention | | | | |

Products 1 and 3 exhibit a high C test, but in parallel they exhibit a low particle size and a low water content. Under ordinary storage conditions, the water regain by the tablets causes their hardness to decrease very rapidly.

The increase in the particle size of these products (example of product 2) causes their compressibility to decrease.

1. Process for preparing beta-cyclodextrin which is of high compressibility and which is stable over time, characterized in that it comprises a step of dehydrating hydrated beta-cyclodextrin to a water content of less than 6%, preferably less than 4% and more preferably still less than or equal to 2% by weight, followed by forced rehydration to a water content greater than 10%, preferably greater than 12% and more preferably still greater than or equal to 13% by weight.

2. Process according to claim 1, characterized in that the dehydration is carried out on a fluidized air bed dryer-granulator.

3. Process according to either of claims 1 and 2, characterized in that the rehydration is carried out on a fluidized air bed granulator.

4. Process according to any one of claims 1 to 3, characterized in that the rehydration is carried out by spraying water at a temperature of less than 60° C., preferably less than 40° C.

5. Beta-cyclodextrin, characterized by a compressibility greater than 70 N expressed in a C test.

6. Beta-cyclodextrin according to claim 5, characterized in that it has a specific surface area according to the BET method greater than or equal to 1 m²/g for a particle size fraction of between 100 and 160 micrometres.

7. Beta-cyclodextrin according to either of claims 5 and 6, characterized in that it has a mean particle diameter greater than 80 micrometres.

8. Beta-cyclodextrin according to any one of claims 5 to 7, characterized in that it has an apparent mass density greater than or equal to 0.45 g/ml, and preferably greater than or equal to 0.50 g/ml, for a particle size fraction of between 100 and 315 micrometres.

9. Beta-cyclodextrin according to any one of claims 5 to 8, characterized in that it exhibits a stability greater than six months at room temperature.
